(19) United States
(12) Patent Application Publication
(10) Pub. No.: US 2011/0264419 A1
(43) Pub. Date: Oct. 27, 2011

(54) Methods for Developing and Using Empirical Models

(76) Inventor: Cyriac J. Wegman, III, Villa Hills, KY (US)

(21) Appl. No.: 12/765,954

(22) Filed: Apr. 23, 2010

(51) Int. Cl. G06F 17/10

(52) U.S. Cl. 703/2

(57) ABSTRACT

A method for providing an empirical model of a defined space comprises steps of: defining the desired space; describing at least a portion of the defined space with multiple correlated dimensions; reducing the dimensionality of the defined portion; combining the described portion with the remaining portion of the defined space; creating a hypothetical model of the defined space; selecting points of interest in the combination; producing real and/or virtual objects associated with at least a portion of the selected points, analyzing at least a portion of the produced objects; calculating coefficients for the hypothetical model according to the analysis.

### FIELD OF THE INVENTION

The invention relates to the development and use of empirical models of systems. The invention relates particularly to the use of virtual simulations in conjunction with empirical analysis to model systems.

### BACKGROUND OF THE INVENTION

Consumer goods are typically designed and/or formulated using empirical methods or basic modeling methodologies. Such efforts are time consuming, expensive and, in the case of empirical methodologies, generally do not result in optimum designs/formulations as not all components and parameters can be considered. Furthermore, aspects of such methods may be limited to existing components. What is desired is a method for modeling systems that enables understanding a defined experimental space without the necessity of performing all possible experiments represented by that space.

### SUMMARY OF THE INVENTION

In one aspect, a method for providing an empirical model of a defined space comprises steps of: defining the desired space; describing at least a portion of the defined space with multiple correlated dimensions; reducing the dimensionality of the defined portion; combining the described portion with the remaining portion of the defined space; creating a hypothetical model of the defined space; selecting points of interest in the combination; producing real and/or virtual objects associated with at least a portion of the selected points, analyzing at least a portion of the produced objects; calculating coefficients for the hypothetical model according to the analysis.

In one aspect, a method for using the model created above comprises predicting properties associated with a real object within the defined space.

In one aspect a method for using the model created above comprises predicting a real object having properties associated with the defined space.

In one aspect the method comprises steps of: defining a formulated product space in terms of a product chassis and an additive; defining potential additives in terms of molecular descriptors; reducing the number of molecular descriptors used to describe the potential additives using statistical methods; creating virtual combinations of the dimensionally reduced description of the potential additives and the product chassis; creating a hypothetical model of the formulated product space; selecting points of interest from the virtual combinations; producing formulated products associated with at least a portion of the selected points of interest; analyzing the produced formulated products, calculating coefficients for the hypothetical model according to the analysis.

In one aspect the above created model may be used to predict the properties of an envisioned product within the defined formulated product space.

In one aspect the above created model may be used to predict a formulated product having specified desired properties.

### DETAILED DESCRIPTION OF THE INVENTION

### Definitions

As used herein “consumer products” includes, unless otherwise indicated, articles, baby care, beauty care, fabric & home care, family care, feminine care, health care, snack and/or beverage products or devices intended to be used or consumed in the form in which it is sold, and is not intended for subsequent commercial manufacture or modification. Such products include but are not limited to home décor, batteries, diapers, bibs, wipes; products for and/or methods relating to treating hair (human, dog, and/or cat), including bleaching, coloring, dyeing, conditioning, shampooing, styling; deodorants and antiperspirants; personal cleansing; cosmetics; skin care including application of creams, lotions, and other topically applied products for consumer use; and shaving products, products for treating fabrics, hard surfaces and any other surfaces in the area of fabric and home care, including: air care, car care, dishwashing, fabric conditioning (including softening), laundry detergency, laundry and rinse additive and/or care, hard surface cleaning and/or treatment, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening; over-the-counter health care including cough and cold remedies, pain relievers, pet health and nutrition, and water purification; processed food products intended primarily for consumption between customary meals or as a meal accompaniment (non-limiting examples include potato chips, tortilla chips, popcorn, pretzels, corn chips, cereal bars, vegetable chips or crisps, snack mixes, party mixes, multigrain chips, snack crackers, cheese snacks, pork rinds, corn snacks, pellet snacks, extruded snacks and bagel chips); and coffee and cleaning and/or treatment compositions.

As used herein, the term “cleaning and/or treatment composition” includes, unless otherwise indicated, tablet, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, car or carpet shampoos, bathroom cleaners; hair shampoos and hair-rinses; shower gels and foam baths and metal cleaners; as well as cleaning auxiliaries such as bleach additives and “stain-stick” or pre-treat types.

As used herein, “component of a consumer product” encompasses consumer product components and packaging.

As used herein, the term “situs” includes paper products, fabrics, garments and hard surfaces.

As used herein, the articles a and an when used in a claim, are understood to mean one or more of what is claimed or described.

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

The method for providing an empirical model of a defined space includes the step of defining the desired space. The desired space refers to the environment that the modeler seeks to better understand. Exemplary spaces include formulated products such as hair care, oral care, skin care or other consumer formulated products, mixing systems such as tank and in-line mixing systems, and manufactured products such as blow molded, including injection-stretch-blow-molded and extrusion-blow-molded, and injection molded objects.

In one embodiment, the defined space may constitute a combination of consumer characteristics and product attributes. In such a space, consumer demographics, social statistics and geographic information may be combined with product attributes to model the acceptance of particular consumer segments to defined product combinations or to select product attributes indicated as desirable by particular consumer segments.

The space may be defined using any set of variables related to the properties relating to the space which may be measured or the inter-relationships of which the modeler seeks to better quantify.

As examples, formulated product spaces may be defined in terms of the ratio and nature of formula components such as surfactants, fatty alcohols, water, salts, together with the weight ranges possible for the combinations of these components, as well as descriptions of candidate additive materials such as flavors, colors, scents and other active ingredients in the overall formula. The additive ingredients may be described in terms of their chemical nature at the molecular level as well as their macroscopic nature.

The properties of the formula such as the viscosity and other rheologic aspects of the products may also be included in the description of the defined space. For a mixing system the space definition may include aspects such as the tank volume and geometry, the mixing temperature, the mixing element geometry and the revolutions per minute the element will operate at, the flow rates at which components are added to the tank, the nature of the components such as the rheology, temperature and the chemical nature of the respective components may all be considered in defining the space. Physical property measures such as x-ray diffraction or differential scanning calorimetry measures associated with the materials being modeled may also be incorporated into the modeled space.

For manufactured products, the material properties of polymers used in extrusion or injection-stretch blow molding or injection molding may be used to describe the space as well as the mechanical properties of the materials at the time the materials will undergo physical transformations along with the range of possible physical transformations in terms of the stresses that the materials will be subjected to during the transformation process. Mold shapes and injection and blowing pressures may be considered and included in the spatial descriptions. The desired properties of the finished articles may also be considered such as the material wall thickness in the article, the reaction of the article to various stress situations such as a top loading or side loading of a bottle in both an empty and filled condition may be included in the spatial description.

The definition of the space may include both continuous and discrete variable descriptions. For example, a formulated space may include a range of possible ratios of components and the ranges of ratios may vary continuously between upper and lower limits. The same formulated product space may also include descriptions of discrete additive candidates and more complete and also descriptions of each discrete additive candidate possibility.

The defined space may not be well suited for modeling due to too high a degree of dimensionality in the definition of the space and the accompanying computational resource issue such a high level of dimensionality creates. In one embodiment the overall dimensionality of the defined space may be reduced by eigenvector-based multivariate analysis of at least a part of the defined space. Such an analysis reduces dimensionality through combining correlated dimensions.

For example, the molecular descriptors of the candidate active ingredients of the formulated products may present a resource issue. In one embodiment about 140 different molecular descriptors may be used to define each of the candidates. In this embodiment, principal component analysis may be used to reduce the dimensionality of the candidate description from the 140 molecular descriptors to about 34 descriptors without an undue loss of accuracy in describing the candidates. In one embodiment the candidates may be defined using COSMOmic parameters in addition to or as a substitute for the molecular descriptors.

In one embodiment, the chassis and/or additive candidates may be simulated at a molecular level in a small volume. These simulations may be used to determine membrane parameters associated with the size, shape, flexibility, melting point, temperature, and other relevant parameters of the membranes related to the particular chassis, additive, or combination thereof. The membrane parameters may be used in addition to, or as a substitute for, the molecular descriptors in the modeling process.

The principal component analysis may be used to redefine the candidates as a table of covariates. The candidates may comprise organic or inorganic chemistries. The candidates may comprise individual chemicals or combinations of chemicals. In one embodiment the dimensionality of a blow-molding model may be reduced by applying eigenvector-based multivariate analysis to the possible reactions of the various portions of the parison to the temperature and mechanical stresses associated with the modeled blow molding process. As a further example, the dimensionality of the mixing system model may be reduced by applying eigenvector-based multivariate analysis to the results of a computational fluid dynamics model for a particular mixing vessel or to the chemical and rheological descriptors of mixed components or a combination of these.

In one embodiment the dimensionally reduced description of a portion of the defined space may be combined with the description of the remainder of the space yielding a dimensionally constrained space. As an example, the dimensionally reduced description of the candidate active additives in the formulated product space may be combined with the description of the remainder of the formula. The remainder of the formula may be described as a set of ratios of various formula components and the ratios may be applied across upper and lower limits of total weight for each of the respective components. Such a description yields a definition according to possible combinations of components that is continuous. In one embodiment the continuous definition may be converted to a discrete definition by selecting particular combinations of the respective components between the upper and lower limits to provide a range of discrete combinations of the components. This set of discrete combinations may be paired with the covariates table of the set of possible additive candidates creating a super-covariates table of the formulated space. In one embodiment either the listing of discrete combinations or the listing of possible additives, or both listings, may be replicated prior to the pairing of the lists. Such a replication of the listing provides for the possibility of a broader range of pairings as each particular individual in each listing may be paired with multiple individuals in the other listing after such a replication. The combination of the two portions of the defined space yields a defined space having a dimensionality that may be more realistic in terms of the computational resources necessary for the modeling tasks.

In one embodiment, the dimensionally reduced portion of the space and/or the remainder of the space may be defined as a set of ranges for the respective variables sued to describe the portions. Points may then be selected as combinations within each of the respective ranges in a manner to either fill the modeled space or to selectively map particular portions of the modeled space as desired.

A model relating aspects of the defined space must be developed. The model may be hypothetical and may be based at least in part upon empirical observations and data. The model may include cross-terms linking disparate variables used to originally define the space and/or used in the dimensionally reduced definition of the space. Higher level cross-terms may be included in the hypothetical model as a way of enabling a better fit of provided data. The model may provide a general description of the inter-relationship of different spatial aspects. The coefficients of the respective cross-terms of the model may be unknown as the model is developed.

The nature of the developed model may reflect the nature of the questions the model is intended to answer. Cross-terms as described above may be used to model interactions of interest in the modeled space. The mathematics of the model may be adapted to suit the needs of the modeler.

The developed model having undefined cross-term coefficients may be used to map the space as defined in the dimensionally reduced form. The mapped space may then be reviewed and particular points within the space may be identified as being of greater interest for further examination. The selection of these points may be made according to their respective location and points may be selected to provide a substantially uniform distribution of these points throughout the space. Space filling algorithms may be used to provide the selected points distributed in the modeled space. Alternatively, the points may be selected to coincide with particular mapped features within the space such as mapped interfaces or areas of rapid change in the value of spatial attributes.

In one embodiment the selection of the points is also made according to the reality the points represents. As an example, for a formulated product comprising an chemical additive, tentatively selected points may be screened to ensure that chemical additive associated with the selection is readily or even actually available for compounding into a sample product. In instances where the tentative selection corresponds to a chemistry which is not readily accessible, an alternative point may be selected as an alternative to the original tentative selection.

Once the points of interest are indentified, the real and/or virtual objects associated with those points are created. Actual sample formulated products, mixing systems, blow and injection molded items and other items associated with the points of the defined space are manufactured.

Virtual objects associated with the points may be created using models developed for that purpose. As an example, a computer simulation may be used to create virtual blow molded containers for analysis. In the event virtual objects are created, the accuracy of the analysis and subsequent uses of the data generated from the analysis may be dependent upon the underlying model used to create the virtual objects. A combination of real and virtual objects associated with the points may be created. After the items are created they are analyzed to determine the particular attributes corresponding to the parameters set forth in the hypothetical model or those attributes which may be used to calculate such parameters. The values of the analyzed attributes are then used to calculate the coefficients of the hypothetical model.

The calculated coefficients are then used together with the generalized model. The model may be used in a variety of ways. In one embodiment the model may be used to predict the attributes of any point in the defined and now modeled space. In one embodiment the model may be used to predict a point in the defined and modeled space having particular attributes. As an example, the model may be used to determine the rheology of a formulated product having an identified base composition together with a particular flavor or other active ingredient. The changes to the rheology associated with changing the active ingredient may be predicted using the model. In another example, the minimum wall thickness and load carrying properties of a blow molded object may be predicted. Alternatively, the formula necessary to provide a particular rheology in a product or the parison attributes necessary to achieve a particular load bearing object may be predicted.

The methods of the disclosed invention may be provided in the form of software, or coded instructions via electronic computer readable media such as, but not limited to, removable disks, flash memory, preprogrammed firmware, dedicated drives and combinations thereof.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for providing an empirical model of a defined space comprising steps of:
a. defining the desired space;
b. describing at least a portion of the defined space with multiple correlated dimensions;
c. reducing the dimensionality of the described portion;
d. combining the described portion with the remaining portion of the defined space;
e. creating a hypothetical model of the defined space; and
f. calculating coefficients for the hypothetical model according to an analysis of real and/or or virtual objects.

2. The method according to claim 1 wherein the step of defining the desired space includes defining a space associated with formulated products.

3. The method according to claim 1 wherein the step of defining a desired space includes defining a space associated with component mixing systems.

4. The method according to claim 1 wherein the step of defining a desired space includes defining a space associated with manufactured articles.

5. The method according to claim 1 wherein the step of reducing the dimensionality of the described portion includes an eigenvector-based multivariate analysis.

6. The method according to claim 1 wherein the step of calculating coefficients for the hypothetical model according to an analysis of real objects includes:
a. selecting points of interest in the combination of the described portion and the remaining portion of the defined space;
b. producing real objects associated with at least a portion of the selected points; and
c. analyzing at least a portion of the produced objects.

7. The method according to claim 6 wherein points of interest are selected according to the hypothetical model developed for the defined space.

8. A method for providing an empirical model of gel network materials comprising steps of:
a. defining the gel network formulation space;
b. describing at least candidate additive materials with multiple correlated dimensions;
c. reducing the dimensionality of the described candidate materials;
d. combining the dimensionally reduced description of the candidate additive materials with the remaining portion of the defined space;
e. creating a hypothetical model of the gel network materials; and
f. calculating coefficients for the hypothetical model according to an analysis of actual gel network materials.

9. The method according to claim 8 wherein the step of defining the gel network formulation space includes:
a. selecting the gel network chassis ingredients;
b. specifying the chassis ingredient weight ranges and cross-relationships; and
c. creating a chassis formulation variables table.

10. The method according to claim 9 wherein the step of describing at least candidate additive materials with multiple correlated dimensions includes:
a. selecting additive candidate materials; and
b. selecting molecular descriptors for the candidate additive materials.

11. The method according to claim 10 wherein the step of reducing the dimensionality of the described candidate materials includes eigenvector-based multivariate analysis of the molecular descriptors of the candidate additive materials.

12. The method according to claim 11 further comprising the step of defining a constrained space according to the eigenvector-based multivariate analysis.

13. The method according to claim 12 wherein the step of combining the dimensionally reduced description of the candidate additive materials with the remaining portion of the defined space includes:
a. specifying the set of principal components covariates for each organic additive candidate;
b. pairing the principal component covariates with the chassis formulation variables table creating a super covariates table; and
c. selecting entries from the super covariates table related to areas of interest of the constrained space.

14. The method according to claim 12 wherein the step of combining the dimensionally reduced description of the candidate additive materials with the remaining portion of the defined space includes:
a. specifying the set of principal components covariates for each organic additive candidate;
b. defining ranges for the chassis formulation and principal component variables; and
c. selecting combinations of points within the defined ranges.

15. The method according to claim 12 wherein the step of calculating coefficients for the hypothetical model according to an analysis of actual gel network materials includes:
a. producing the materials associated with the selected entries in the super covariates table;
b. analyzing the produced materials;
c. calculating interaction cross-term coefficients for the hypothetical model according to the analysis. (this claim is specific to the gel network model, the broad claim is not as restricted to this mathematics)
